(19) United States
(12) Patent Application Publication
(10) Pub. No.: US 2014/0251056 A1
(43) Pub. Date: Sep. 11, 2014

(54) ROBOTIC ARM ASSEMBLY WITH ANGULAR CONTACT CARTRIDGE BEARINGS

(71) Applicant: AGILENT TECHNOLOGIES, INC., Loveland, CO (US)

(72) Inventor: Adam Preuss, Loveland, CO (US)

(73) Assignee: AGILENT TECHNOLOGIES, INC., Loveland, CO (US)

(21) Appl. No.: 13/787,322

(22) Filed: Mar. 6, 2013

(51) Int. Cl. B25J 17/00; B23P 11/00

(52) U.S. Cl. CPC B25J 17/00; B23P 11/00; Y10S 901/28
USPC 74/490.05; 29/428; 901/28

(57) ABSTRACT

A robotic arm assembly includes a first arm and second arm coupled by a shaft and bearing assembly, forming a joint at which the first arm rotates about a joint axis. The bearing assembly includes angular contact cartridge bearings contacting corresponding angled surfaces of the assembly, and a bearing cap. The shaft is attached to the first arm, extends through the second arm, and is attached to the bearing cap such that the bearing assembly is axially compressed between the bearing cap and the first arm. The bearing assembly may include components for preloading the bearing assembly and enabling components to self-align during assembly.

### TECHNICAL FIELD

The present invention relates generally to robotic arm assemblies and robots including such assemblies. More particularly, the invention relates to robotic arm assemblies utilizing angular contact cartridge bearings and methods of manufacturing such assemblies.

### BACKGROUND

Robots may be utilized in laboratory settings to perform in tasks involving precise and often repetitive motions and manipulations within a defined workspace. A robot utilized in a life sciences laboratory may include one or more arm components that are linearly movable along one or more axes and/or rotatable about an axis, and mechanisms for driving the movement(s) of the arm components. The robot may further include one or more movable end effectors supported by the arm component(s). The end effector may be configured for a variety of tasks, such as picking up objects (e.g., labware) and moving them from one place to another within the workspace. The robot may, for example, be associated with an automated sample handling apparatus at which holders for liquid containers and other labware may be positioned. Examples of labware include containers such as multi-well plates, tubes, vials, cuvettes, pipette tips, reservoirs, as well as tools, instruments, devices, and other components requiring placement, transportation and possibly subsequent removal. The robot may move labware to and from different stations or instruments providing various functions such as storage, rinsing/washing, heating, agitating/shaking/centrifuging, vacuum filtration, weighing, sample preparation, sample analysis, etc. The movements of the robot may be controlled by electronics, and control may depend in part of feedback from sensors. The robot may provide automated and/or user-implemented control over a series of movements and handling operations. A procedure involving multiple steps requiring movement may be controlled by a pre-programmed set of software instructions.

A pair of arm components of the robot may be coupled together at a rotational joint that allows at least one of the arm components to rotate relative to the other. The joint may include a bearing assembly that enables freedom of movement about a desired axis while minimizing wear and damage caused by frictional contact between surfaces. In some robots, the bearing assembly utilizes cartridge bearings with square cross-sections. These types of bearings are available in a large variety of sizes as catalog items and the mounting geometry for mating parts is well defined. However, the dimensional tolerances required for these bearings to work well in robotic joints are very fine, which increases the cost to produce the parts that mate with the bearings. There is a great deal of cost sensitivity as these dimensional tolerances decrease. For example, the cost may rise exponentially for tolerances below 0.005 inches. Moreover, while these bearings may be listed as catalog items, the bearing sizes required for certain robots may be less popular, leading to a lack of stability in the supply chain. Unless there is great demand for a particular size of bearing from a particular supplier, the lead time to acquire bearings can be long and sporadic. As manufacturing continues to move toward lean processes, vendors may not carry large inventories of less popular items particularly if they believe the relatively low demand for such items does not justify the costs associated with maintaining the inventory, distributing the items to consumers, etc.

In view of the foregoing, there is a need for providing robotic devices utilizing bearing assemblies with relatively low-cost components, and which require less stringent dimensional tolerances to make the manufacturing of mating components easier and less costly.

### SUMMARY

To address the foregoing problems, in whole or in part, and/or other problems that may have been observed by persons skilled in the art, the present disclosure provides methods, processes, systems, apparatus, instruments, and/or devices, as described by way of example in implementations set forth below.

According to one embodiment, a robotic arm assembly includes: a first arm; a second arm comprising a bore extending along a joint axis from a first opening to a second opening; a shaft attached to the first arm and extending through the bore; a first annular angled surface; a second annular angled surface; and a bearing assembly coupling the first arm to the second arm wherein the first arm is rotatable relative to the second arm, the bearing assembly including: a first portion positioned coaxially about the shaft between the first arm and the first opening, the first portion comprising a first angular contact cartridge bearing contacting the first annular angled surface; a bearing cap; and a second portion positioned coaxially about the shaft between the second opening and the bearing cap, the second portion comprising a second angular contact cartridge bearing contacting the second annular angled surface, wherein the bearing cap is secured to the shaft such that the bearing assembly is compressed along the joint axis.

According to another embodiment, a robot includes: a support component; a plurality of arms, wherein each arm is coupled to at least one other arm, and at least one of the arms is coupled to the support component; and a plurality of joints, wherein each joint couples a respective arm to at least one other arm, and wherein at least one pair of arms and corresponding joint is a robotic arm assembly as described herein.

According to another embodiment, a method for assembling a robotic arm assembly includes: installing a first cartridge bearing around a shaft that extends from a first arm along a joint axis; inserting the shaft through a bore of a second arm such that the first cartridge bearing is between the first arm and the second arm; installing a second cartridge bearing around the shaft; installing a bearing cap on the shaft such that the second cartridge bearing is between the second arm and the bearing cap; and bringing an angled contact surface of the first cartridge bearing into contact with a first annular angled surface, and bringing an angled contact surface of the second cartridge bearing into contact with a second annular angled surface, by applying axial compression between the bearing cap and the first arm along the joint axis, wherein the first cartridge bearing and the second cartridge bearing become aligned with the bore and centered about the joint axis.

Other devices, apparatus, systems, methods, features and advantages of the invention will be or will become apparent to one with skill in the art upon examination of the following figures and detailed description. It is intended that all such additional systems, methods, features and advantages be included within this description, be within the scope of the invention, and be protected by the accompanying claims.

### BRIEF DESCRIPTION OF THE DRAWINGS

The invention can be better understood by referring to the following figures. The components in the figures are not necessarily to scale, emphasis instead being placed upon illustrating the principles of the invention. In the figures, like reference numerals designate corresponding parts throughout the different views.

FIG. 1 is a perspective view of an example of a robot according to some embodiments.

FIG. 2 is a top plan view of the example of the robot illustrated in FIG. 1.

FIG. 3 is a perspective exploded view of an example of a robotic arm assembly according to some embodiments.

FIG. 4 is a cut-away perspective view of a portion of the robotic arm assembly illustrated in FIG. 3.

FIG. 5 is a detailed view of a region of the robotic arm assembly illustrated in FIG. 4.

### DETAILED DESCRIPTION

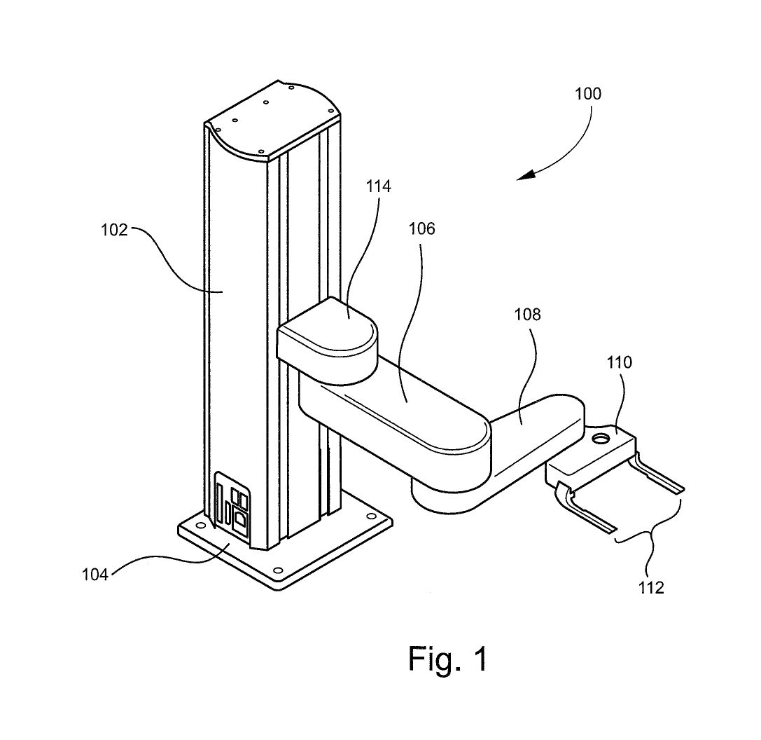

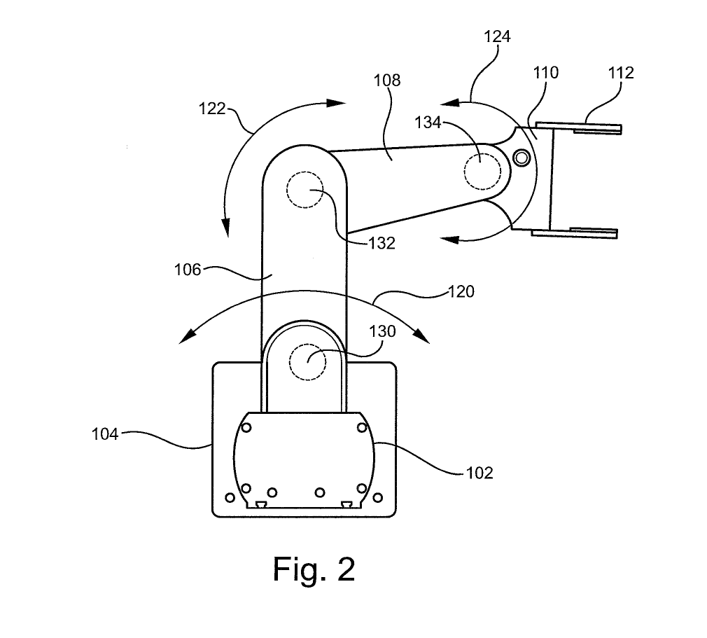

FIG. 1 is a perspective view of an example of a robot 100 (or robotic assembly) according to some embodiments. FIG. 2 is a top view of the robot 100. Generally, the robot 100 may include support components, arm components (or arms), and joints. The support components may include a mast 102 supported on a base 104, which may be used to attach the robot 100 to a bench or other desired support surface. The arm components include one or more rotatable arms such as an arm (or bicep) 106 and an arm (or forearm) 108, and an end effector (or hand) 110. In the illustrated embodiment, the arm 106 is coupled to an arm support 114 of the mast 102 by a joint (or shoulder) 130. The arm support 114 may include an actuator (or driver) that rotates the arm 106 about the axis of the joint 130. The arm support 114 may be coupled to a linear actuator of the mast 102 such that the entire robotic assembly (arms 106 and 108 and end effector 110) is movable up and down (z-axis) along the mast 102. The arm 108 is coupled to the arm 106 by a joint (or elbow) 132. The arm 106 may include an actuator that rotates the arm 108 about the axis of the joint 132. The end effector 110 is coupled to the arm 108 by a joint (or wrist) 134. The arm 108 may include an actuator that rotates the end effector 110 about the axis of the joint 134. The end effector 110 may include a gripper 112, such as two or more two movable finger-like structures, configured for gripping labware whereby the robot 100 may be operated to transport labware to different sites within the reach of the robot 100.

FIG. 2 illustrates examples of movements of the robotic components. In the illustrated embodiment, the arm 106 may rotate about the axis of the joint 130 as depicted by an arc 120, the arm 108 may rotate about the axis of the joint 132 as depicted by an arc 122, and the end effector 110 may rotate about the axis of the joint 134 as depicted by an arc 124. One or more of these components may be capable of full rotation (infinite rotation) on the corresponding joint axis, or the rotation of one or more of these components may be limited to a range less than 360 degrees, depending on the particular embodiment.

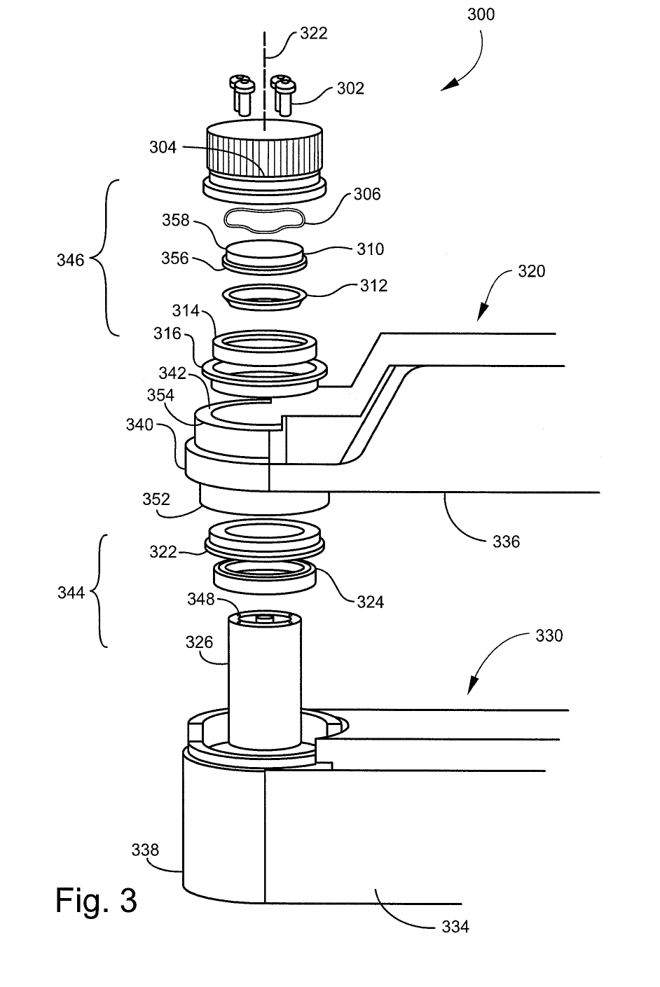

FIG. 3 is a perspective exploded view of an example of a robotic arm assembly 300 according to some embodiments. One or more robotic arm assemblies 300 may be utilized in a robot such as that illustrated in FIGS. 1 and 2. The robotic arm assembly 300 may generally include a first arm 330, another robotic component such as a second arm 320, an axle or shaft 326, and a bearing assembly (or joint assembly). The shaft 326 and bearing assembly couple the first arm 330 to the second arm 320 such that the first arm 330 is rotatable about a joint axis (or pivot axis) 332 relative to the second arm 320. As examples, the first arm 330 may correspond to the end effector 110, arm 108, or arm 106, and the second arm 330 may correspond to the arm 108, arm 106, or arm support 114 shown in FIGS. 1 and 2. The bearing assembly may be located at any of the joints 130, 132 and 134 shown in FIGS. 1 and 2.

The first arm 330 and second arm 320 may generally include respective bodies or housings. One or both bodies 334 and 336 may be at least partially hollow to enclose functional components such as, for example, drive mechanisms, sensors, electronic circuits, etc. In some embodiments the shaft 326 and bearing assembly, and the joint axis 332 defined thereby, are located at ends 338 and 340 of the first arm 330 and second arm 320. The second arm 320 includes a bore 342 at the end 340 that extends from a first opening 352 to a second opening 354, and is oriented such that the joint axis 332 passes therethrough. The first arm 330 and second arm 320 may be elongated along axes orthogonal to the joint 332. The shaft 326 is attached to the first arm 330 such that it extends along the joint 332 and through the bore 342.

The bearing assembly may generally include a first portion 344 disposed between the first arm 330 and the second arm 320, a bearing cap 304, and a second portion 346 disposed between the second arm 320 and the bearing cap 304. The first portion 344 and second portion 346 are configured to secure the shaft 326 to second arm 320 in a manner that enables the shaft 326 and the first arm 330 to rotate together about the joint axis 332 with minimal frictional contact and heat generation. For this purpose, several components of the first portion 344 and second portion 346 are annular and provide radial space between the shaft 326 and the bore 342. Upon assembly, the bearing components are positioned coaxially about the shaft 326 and axially compressed along the joint axis 332. Axial compression and securing of the assembled components may be achieved, for example, using one or more suitable fasteners 302 that pass through the bearing cap 304 and into secure engagement with the shaft 326 or the first arm 330. The fasteners 302 may, for example, cause the bearing cap 304 to bear down on the second portion 346, the second portion 346 to bear down on the second arm 320, the second arm 320 to bear down on the first portion 344, and the first portion 344 to bear down on the first arm 330. In the illustrated embodiment, the fasteners 302 are threaded and pass through apertures of the bearing cap 304 and into mating engagement with threaded bores 348 of the shaft 326 such that rotation of the fasteners 302 axially translates them along the joint axis 332.

In the illustrated embodiment, the first portion 344 of the bearing assembly includes a first cartridge bearing 324 and a first bearing seat 322, and the second portion 346 includes a second cartridge bearing 314 and a second bearing seat 316. The first cartridge bearing 324 and second cartridge bearing 314 are angular contact cartridge bearings. As appreciated by persons skilled in the art, each cartridge bearing 324 and 314 includes an annular inner race, an annular outer race, and a set of rolling elements (balls, cylinders, pins, etc.) that are free to roll along a circumference between the inner and outer races. Each cartridge bearing 324 and 314 may also include one or more seals that isolate the rolling elements from the ambient. Each cartridge bearing 324 and 314 includes an angular or tapered contact surface (angled relative to the joint axis 332) that contacts a complementary angular or tapered contact surface of the robotic arm assembly 300, as described further below. During assembly, the first cartridge bearing 324 and first bearing seat 322 are inserted around the shaft 326 and the first bearing seat 322 is seated in the bore 342 of the second arm 320 at the first opening 352. Accordingly, the first cartridge bearing 324 is disposed between the first arm 330 and the first bearing seat 322, and the first bearing seat 322 is disposed between the first cartridge bearing 324 and the second arm 320. The shaft 326 is then inserted through the bore 342, the second bearing seat 316 and second cartridge bearing 314 are inserted around the shaft 326, the second bearing seat 316 is seated in the bore 342 at the second opening 354, and the bearing cap 304 is installed on the shaft 326. Accordingly, the second bearing seat 316 is disposed between the second aim 320 and the second cartridge bearing 314, and the second cartridge bearing 314 is disposed between the second bearing seat 316 and the bearing cap 304.

Also in the illustrated embodiment, the second portion 346 of the bearing assembly includes components configured for aligning and sealing the bearing assembly against the shaft 326, and for preloading (applying axial force to) the cartridge bearings 324 and 314. As shown, the second portion 346 includes a bearing preload spring 306, a spring alignment spacer 310, and a compression ring 312. The bearing preload spring 306 may be an annular wave spring that flattens out under compression to transfer axial force. The spring alignment spacer 310 includes an annular base 356 and an annular side wall 358 extending from the base 356 in parallel with the joint axis 332, such that the base 356 and side wall 358 form an annular outer shoulder. The compression ring 312 includes an annular angled (or tapered) surface.

During assembly, the spring 306, spacer 310 and compression ring 312 are inserted around the shaft 326 such that the compression ring 312 is disposed between the first cartridge bearing 324 and the base 356 of the spacer 310, the spacer base 356 is disposed between the compression ring 312 and the spring 306, and the spring 306 is disposed between the spacer base 356 and the bearing cap 304. The spring 306 is installed on the outer shoulder of the spacer 310 such that the spring 306 coaxially surrounds the side wall 358 of the spacer 310. The compression ring 312 contacts the shaft 326, first cartridge bearing 324 and spacer 310 in a manner described below. The fasteners 302 are then installed, which in the present embodiment entails threading the fasteners 302 into the shaft 326 as described above, by employing an appropriate tool to apply torque to the fasteners 302. As the fasteners 302 begin to engage the shaft 326, the spring 306 flattens out and transfers axial force to the rest of the bearing assembly. The components of the bearing assembly settle into their respective positions in proper alignment with each other and with the shaft 326. Also, the compression ring 312 becomes compressed to form sealed interfaces with the shaft 326, first cartridge bearing 324 and spacer 310. After preloading the bearing assembly in this manner, additional torque is applied to the fasteners 302 until the desired amount of torque and resulting axial compression have been achieved, thereby completing the assembly.

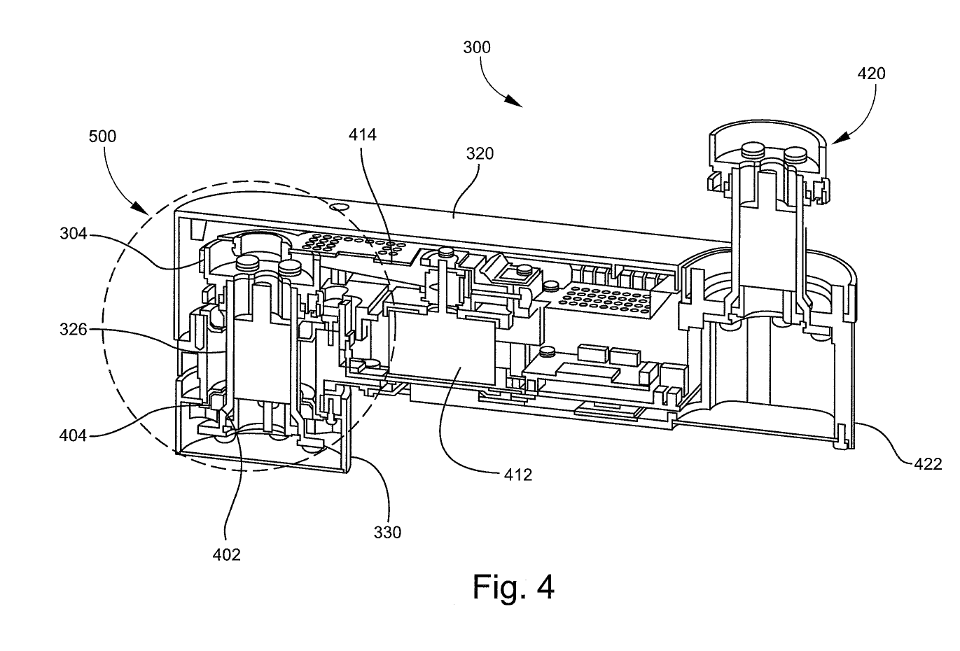

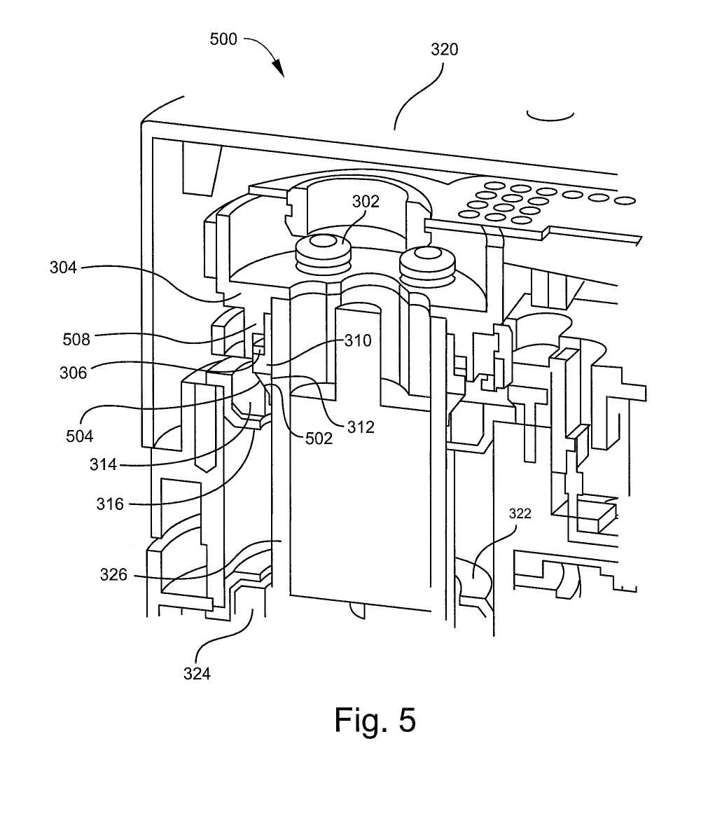

FIG. 4 is a cut-away perspective view of a portion of the robotic arm assembly 300 in assembled form, illustrating the second arm 320 and a portion of the first arm 330. FIG. 5 is a detailed view of a region of the robotic arm assembly 300 designated 500 in FIG. 4. In the present embodiment shown in FIG. 4, a section of the outer surface of the shaft 326 provides an annular angled surface 402 with which an angled contact surface 404 of the first cartridge bearing 324 contacts. As shown in FIG. 5, an annular angled surface 502 of the compression ring 312 contacts an angled contact surface 504 of the second cartridge bearing 314. Also, the compression ring 312 includes a top surface contacting the base of the spring alignment spacer 310 and an inside surface contacting the shaft 326. The compression ring 312 may also include a cylindrical section that occupies an annular gap between the shaft 326 and the second cartridge bearing 314. As further shown in FIG. 5, a portion of the inside surface of the bearing cap 304 may define an annular inner shoulder 508 that is shaped complementarily to the outer shoulder (base and side wall) of the spring alignment spacer 310, and the bearing preload spring 306 is positioned between these shoulders. While FIG. 5 shows an axial gap between the inner shoulder 508 and the spring 306, the gap may or may not exist after final assembly.

It can be seen that the provision of cartridge bearings 324 and 314 with angled contact surfaces 404 and 502, in conjunction with the bearing preload spring 306, enable the cartridge bearings 324 and 314 to self-align during assembly of the robotic arm assembly 300 such that they are properly seated in the bore 342 and centered about the joint axis 332. Moreover, angled contact cartridge bearings 324 and 314 are not as constrained by the dimensional tolerance requirements of other types of bearings utilized in robotic joints, thus easing the fabrication and lowering the cost of the components mated to these cartridge bearings 324 and 314.

In the present embodiment, the robotic arm assembly 300 further includes a drive assembly configured for driving the rotation of the first arm 330 relative to the second arm 320, by means of the shaft 326 and bearing assembly, in either direction (clockwise or counterclockwise) about the joint axis 332. As shown in FIG. 4, the drive assembly includes a driver 412 (drive mechanism or device, actuator, etc.) and a linkage 414 disposed in the body of the second arm 320. The linkage 414 is coupled between the driver 412 and the bearing cap 304, which serves as the driven component (e.g., a drive pulley or sheave) of the drive assembly. The driver 412 and linkage 414 may have any configuration suitable for enabling the driver 412 to impart motion to the linkage 414 and the linkage 414 to in turn impart motion to the bearing cap 304 (and thus to the shaft 326 and first arm 330). In some embodiments, the linkage 414 is a flexible loop such as a belt or chain. The inner side of the linkage 414 may include mating elements configured to engage mating elements provided on an outer section of the bearing cap 304 (e.g., grooves and ribs as partially shown in FIG. 5, or mating teeth, pins and holes, V-shaped surfaces, etc.). The driver 412 may, for example, include a motor and an actuator engaging the linkage 414, and more generally may have any other suitable configuration as appreciated by persons skilled in the art.

As also illustrated in FIG. 4, the robotic arm assembly 300 may include another joint assembly 420 (including a shaft, bearing assembly, etc.) located at an opposite end 422 of the second arm 320. The bearing cap of this other joint assembly 420 may be driven by the drive assembly of another arm (not shown) or other type of robotic component coupled to the second arm 320 at the other joint assembly 420. It is also evident that the first arm 330 may include another joint assembly (not shown) at its other end, and may further include a drive assembly for driving yet another arm (not shown). More generally, any of the joints provided by a robot such as illustrated in FIGS. 1 and 2 may be configured and operate as described above in conjunction with FIGS. 3 to 5.

It will be understood that terms such as “communicate” and “in . . . communication with” (for example, a first component “communicates with” or “is in communication with” a second component), and terms such as “coupled to” and “attached to,” are used herein to indicate a structural, functional, mechanical, electrical, signal, optical, magnetic, electromagnetic, ionic or fluidic relationship between two or more components or elements. As such, the fact that one component is said to communicate with or be coupled to a second component is not intended to exclude the possibility that additional components may be present between, and/or operatively associated or engaged with, the first and second components. Likewise, it will be understood that when a component is referred to as being “on” or “over” another component, or “between” other components, that component may be directly or actually on (or over) the other component or directly between other components or, alternatively, intervening components may also be present.

It will be understood that various aspects or details of the invention may be changed without departing from the scope of the invention. Furthermore, the foregoing description is for the purpose of illustration only, and not for the purpose of limitation—the invention being defined by the claims.

What is claimed is:

1. A robotic arm assembly, comprising:
a first arm;
a second arm comprising a bore extending along a joint axis from a first opening to a second opening;
a shaft attached to the first arm and extending through the bore;
a first annular angled surface;
a second annular angled surface; and
a bearing assembly coupling the first arm to the second arm wherein the first arm is rotatable relative to the second arm, the bearing assembly comprising:
a first portion positioned coaxially about the shaft between the first arm and the first opening, the first portion comprising a first angular contact cartridge bearing contacting the first annular angled surface;
a bearing cap; and
a second portion positioned coaxially about the shaft between the second opening and the bearing cap, the second portion comprising a second angular contact cartridge bearing contacting the second annular angled surface,
wherein the bearing cap is secured to the shaft such that the bearing assembly is compressed along the joint axis.

2. The robotic arm assembly of claim 1, comprising a fastener extending through the bearing cap and attached to the shaft.

3. The robotic arm assembly of claim 2, wherein the shaft comprises a threaded bore, and the fastener comprises a thread engaged with the threaded bore.

4. The robotic arm assembly of claim 1, wherein the shaft comprises an outer surface, and the outer surface comprises the first annular angled surface.

5. The robotic arm assembly of claim 1, wherein the first portion comprises a bearing seat seated in the first opening, and the first angular contact cartridge bearing is positioned between the first arm and the bearing seat.

6. The robotic arm assembly of claim 1, wherein the second portion comprises a compression ring, and the compression ring comprises the second annular angled surface.

7. The robotic arm assembly of claim 1, wherein the second portion comprises a bearing seat seated in the second opening, and the second angular contact cartridge bearing is positioned between the bearing seat and the bearing cap.

8. The robotic arm assembly of claim 7, comprising a compression ring between the second angular contact cartridge bearing and the bearing cap.

9. The robotic arm assembly of claim 8, comprising a spacer, the spacer comprising a base and an annular side wall extending axially from the base, and further comprising an annular preload spring coaxial with the side wall, wherein the base is positioned between compression ring and the bearing cap and the annular preload spring is positioned between the base and the bearing cap.

10. The robotic arm assembly of claim 1, wherein the second arm comprises a driver and a linkage communicating with the driver and the bearing cap, wherein the driver is configured for actuating the linkage and the linkage is configured for rotating the bearing cap about the joint axis, and wherein the first arm is rotatable with the bearing cap.

11. The robotic arm assembly of claim 10, wherein the linkage comprises a flexible loop.

12. The robotic arm assembly of claim 1, wherein:
the first portion comprises a first bearing seat seated in the first opening, and the first angular contact cartridge bearing is positioned between the first arm and the first bearing seat; and
the second portion comprises:
a second bearing seat seated in the second opening, and the second angular contact cartridge bearing is positioned between the second bearing seat and the bearing cap;
a compression ring between the second angular contact cartridge bearing and the bearing cap;
a spacer between compression ring and the bearing cap; and
an annular preload spring between the spacer and the bearing cap.

13. A robot, comprising:
a support component;
a plurality of arms, wherein each arm is coupled to at least one other arm, and at least one of the arms is coupled to the support component; and
a plurality of joints, wherein each joint couples a respective arm to at least one other arm, and wherein at least one pair of arms and corresponding joint is a robotic arm assembly according to claim 1.

14. The robot of claim 13, wherein at least one of the arms is an end effector comprising a gripper.

15. A method for assembling a robotic arm assembly, the method comprising:
installing a first cartridge bearing around a shaft that extends from a first arm along a joint axis;
inserting the shaft through a bore of a second arm such that the first cartridge bearing is between the first arm and the second arm;
installing a second cartridge bearing around the shaft;
installing a bearing cap on the shaft such that the second cartridge bearing is between the second arm and the bearing cap; and
bringing an angled contact surface of the first cartridge bearing into contact with a first annular angled surface, and bringing an angled contact surface of the second cartridge bearing into contact with a second annular angled surface, by applying axial compression between the bearing cap and the first arm along the joint axis, wherein the first cartridge bearing and the second cartridge bearing become aligned with the bore and centered about the joint axis.

16. The method of claim 15, wherein applying axial compression comprises contacting a fastener with the bearing cap and engaging the fastener with the shaft of the first arm.

17. The method of claim 15, wherein the angled contact surface of the first cartridge bearing is brought into contact with an annular angled surface of the shaft.

18. The method of claim 15, comprising installing a bearing seat on the shaft and seating the bearing seat in the bore, wherein applying axial compression seats the first cartridge bearing or the second cartridge bearing in the bearing seat.

19. The method of claim 15, comprising installing a compression ring on the shaft, wherein applying axial compression compresses the compression ring and forms a seal between the first cartridge bearing and the shaft.

20. The method of claim 19, comprising installing a spring around the shaft between the first cartridge bearing and the bearing cap, wherein applying axial compression causes the spring to impart force to the first cartridge bearing.
